(19) United States
(12) Patent Application Publication
(10) Pub. No.: US 2005/0188387 A1
(43) Pub. Date: Aug. 25, 2005

(54) Combination display base and pre-recorded data storage medium

(76) Inventor: Michael Sean Kelley, Matthews, NC (US)

Correspondence Address: SCHWARTZ LAW FIRM, P.C., 6100 FAIRVIEW ROAD, SUITE 530, CHARLOTTE, NC, 28210, US

(21) Appl. No.: 11/063,023

(22) Filed: Feb. 22, 2005

Related U.S. Application Data
(60) Provisional application No. 60/546,534, filed on Feb. 20, 2004.

(51) Int. Cl. G11B 33/02

(52) U.S. Cl. 720/601

(57) ABSTRACT

A display base includes a housing adapted for placement on a supporting surface for display. The housing defines a slot adapted for removably receiving a pre-recorded data storage disk. The data storage disk contains communications media documenting a person, place, thing, or event. A tray is slidably received through the slot formed with the housing, and is adapted for movement between a closed position substantially inside of the housing and an open position substantially outside of the housing. A raised hub insert is located on a surface of the disk tray, and is adapted for releasably holding the data storage disk upon movement of the disk tray between the closed and open positions.

### TECHNICAL FIELD AND BACKGROUND OF THE INVENTION

The present invention relates to a combination display base and pre-recorded data storage medium. The data storage medium, typically a machine-readable disk, contains communications media, such as voice, data, video, text, and graphics, which documents a person, place, thing, or event. The invention is especially applicable as a commemorative.

The recent rise and now prevalence of DVD players has lead to a rapid growth in the production of DVD recordings. Commemorative recordings are particularly popular in sports and entertainment, and include programs commemorating athletic teams, games, performances, events, stadiums and arenas. Machine-readable disks, such as DVD's and CD's, are a particularly suitable medium for such recordings as the quality will not degrade or deteriorate over time as does a typical VHS video tape. It is desirable to the owners of such commemorative DVD's and CD's to avoid scratching or damage to the disk, and to maintain the disk in good condition so that it can be enjoyed many years in the future, thereby enhancing the value of the commemorative DVD and CD as a keepsake and memorial. Accordingly, it is desirable to safely store the disk in an appropriate manner, and in a display having an appearance consistent with the commemorative purpose of the DVD and CD.

### SUMMARY OF THE INVENTION

Therefore, it is an object of the invention to provide a combination display base and pre-recorded machine-readable disk commemorating a person, place, thing, or event.

It is another object of the invention to provide a commemorative display base which safely stores and protects the disk.

It is another object of the invention to conveniently match a commemorative display base and pre-recorded disk containing a media presentation relating to the commemorative.

It is another object of the invention to provide a method for commemorating a person, place, thing, or event.

These and other objects of the present invention are achieved in the preferred embodiments disclosed below by providing a combination display base and pre-recorded data storage medium containing communications media documenting a person, place, thing, or event. The display base includes a housing adapted for placement on a supporting surface for display. The housing defines a slot removably receiving the data storage medium for temporarily storing the data storage medium within the display base.

The term “pre-recorded data storage medium” comprises any recordable medium including, but not limited to, paper, audio and video tapes, and computer-readable disks including high-density compact disks (DVD's), optical disks (CD's), floppy disks, and the like.

According to another preferred embodiment, a tray carries the data storage medium and is slidably received through the slot formed with the housing. The tray is movable between a stowed position substantially inside of the housing, and an open position substantially outside of the housing. The term “substantially” as used herein means greater than 50%.

According to another preferred embodiment, means are formed with the tray for releasably holding the data storage medium.

According to another preferred embodiment, the means for releasably holding the data storage medium comprises a raised hub insert. Other suitable means for holding comprise other raised portions formed with the inside of the tray, friction pads, clips, and the like.

According to another preferred embodiment, a handle is attached to the tray for being gripped by a user to move the tray between the stowed and open positions.

According to another preferred embodiment, the housing has a generally flat top defining a display surface.

According to another preferred embodiment, a commemorative is carried on the display surface of the housing. The term “commemorative” refers to any object which honors or preserves the memory of, or calls to mind, a person, place, thing or event.

According to another preferred embodiment, a placard is attached to the housing.

According to another preferred embodiment, the data storage medium is a compact disk.

According to another preferred embodiment, the communications media is selected from a group consisting of text, graphics, voice, data and video.

In another embodiment, the invention is a commemorative display base. The display base includes a housing adapted for placement on a supporting surface for display. The housing defines a slot adapted for removably receiving a pre-recorded data storage disk. The data storage disk contains communications media documenting a person, place, thing, or event. A tray is slidably received through the slot formed with the housing, and is adapted for movement between a stowed position substantially inside of the housing and an open position substantially outside of the housing. A raised hub insert is located on a surface of the disk tray, and is adapted for releasably holding the data storage disk upon movement of the disk tray between the stowed and open positions.

In yet another embodiment, the invention is a method for commemorating a person, place, thing, or event. The method includes the step of placing a pre-recorded data storage medium inside a display base. The data storage medium contains communications media documenting the person, place, thing, or event.

The term “commemorating” means honoring or preserving the memory of, or calling to mind, a person, place, thing, or event.

According to another preferred embodiment, the method includes the step of locating a commemorative on a display surface defined by the display base.

According to another preferred embodiment, the method includes the step of attaching a placard to the display base.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view of a commemorative display base according to one preferred embodiment of the present invention, and showing the disk tray in a closed position substantially within the housing;

FIG. 2 is a perspective view of the display base with the disk tray in a partially open/closed position;

FIG. 3 is a cross-sectional view of the display base;

FIG. 4 is a top view of the display base with the disk tray removed and shown separately;

FIG. 5 is a front view of the display base with the disk tray removed;

FIG. 6 is a perspective view of the display base with a commemorative located on a display surface of the housing, and an attached placard—the commemorative and placard being shown in phantom; and

FIG. 7 is an exploded view of the display base.

### DESCRIPTION OF THE PREFERRED EMBODIMENT AND BEST MODE

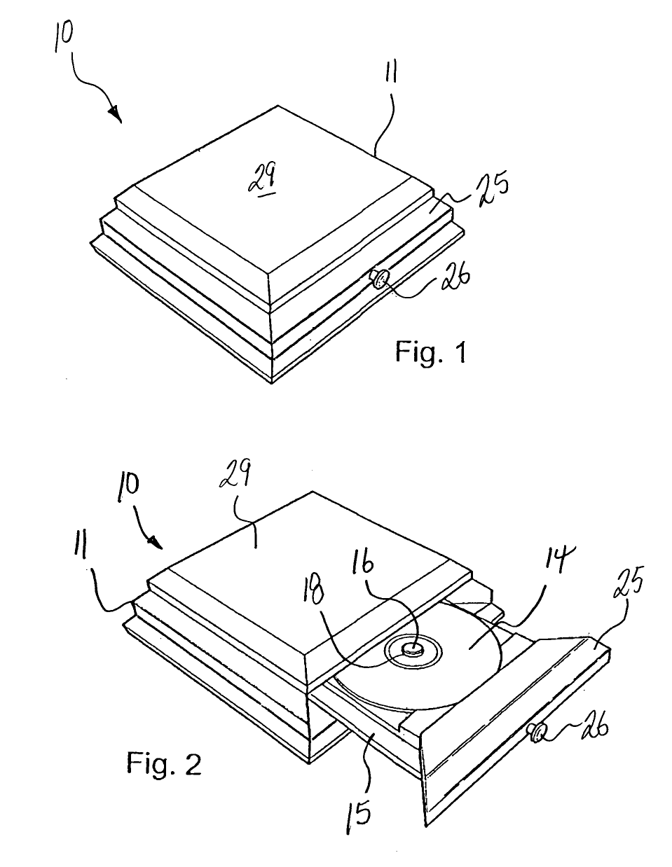

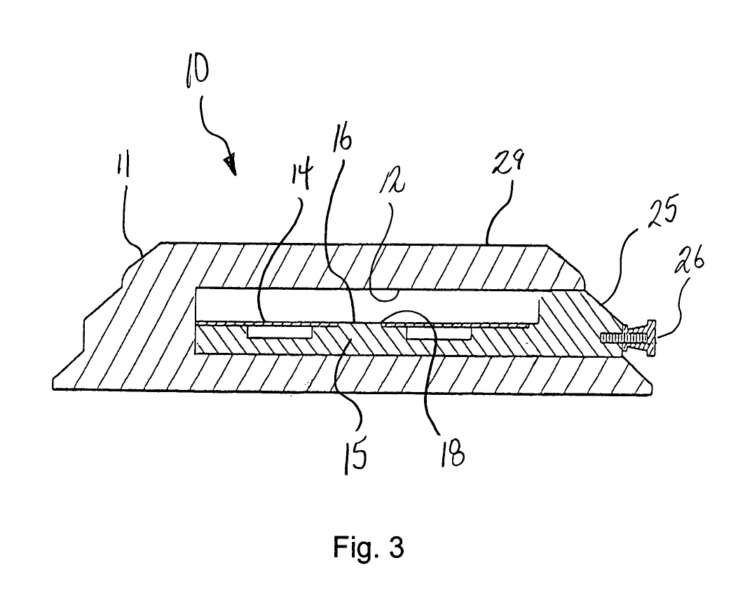

Referring now specifically to the drawings, a commemorative display base according to a preferred embodiment of the present invention is illustrated in FIG. 1, and shown generally at reference numeral 10. The display base 10 comprises a housing 11 with a generally flat bottom for locating the base 10 on a supporting surface for display, and a slot 12 (See FIG. 3) designed for temporarily storing a pre-recorded data storage medium 14, such as a DVD, CD, video tape, or audio cassette. For purposes of illustration, the data storage medium 14 is referred to hereinafter as a “disk” although other known forms of data storage are contemplated.

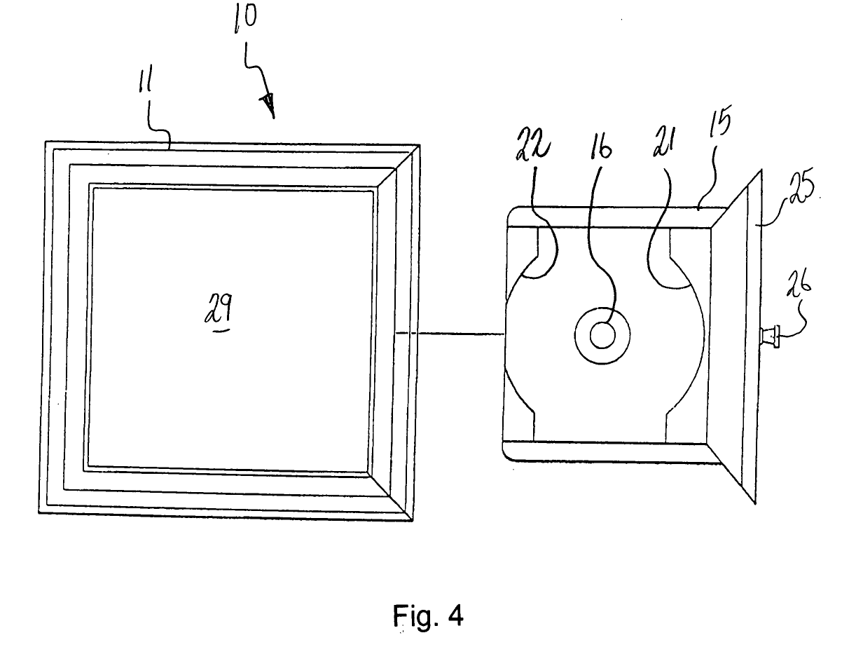

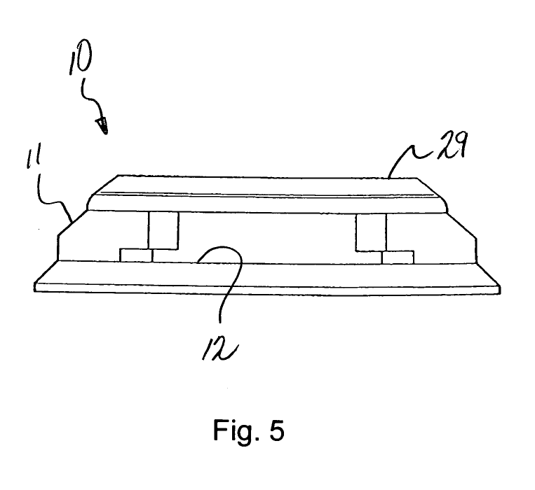

The disk 14 is carried on a tray 15 slidably received within the housing slot 12, and adapted for movement between a closed position, shown in FIGS. 1 and 3, and an open position. FIG. 2 shows in the tray 15 in a partially open/closed position. The disk 14 is releasably secured to suitable structure including a raised hub insert 16 formed with the tray 15 and designed to fit within a hub opening 18 of the disk 14, as best shown in FIGS. 2, 3 and 4. In the open tray position, the disk 14 is readily accessible and conveniently removed from the tray 15 and display base 10. In the closed tray position, the disk 14 is entirely concealed and protected inside the housing 11 and conveniently matched with the display base 10. FIGS. 4 and 5 show the tray 15 completely removed from the housing 11. Preferably, the inside surface of the tray 15 further defines opposing raised arcuate sides 21 and 22, best shown in FIG. 4, designed to accommodate the disk 14 and prevent inadvertent shifting as the tray 15 is opened and closed within the housing 11. The inside tray surface may include other raised structure for accommodating any disk shape, such as 3-inch mini disks and business card sized disks. According to one embodiment, the tray 15 is formed of wood and has an integral decorative wood face 25 with a handle 26 for conveniently moving the tray 15 between the open and closed positions. The tray 15 may also be formed of a molded plastic or any other suitable material.

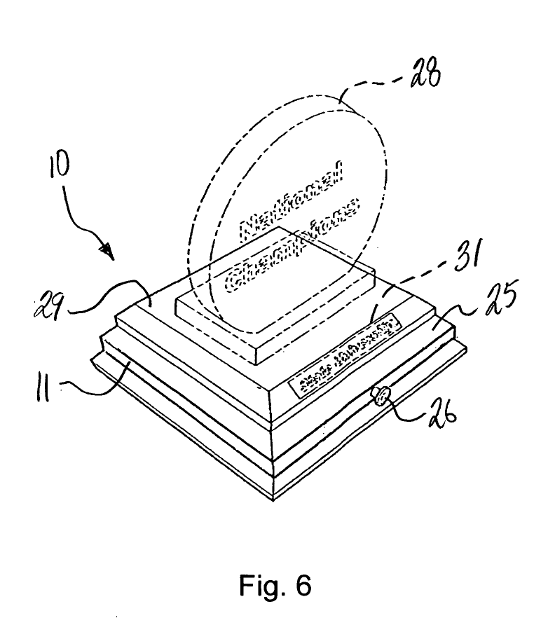

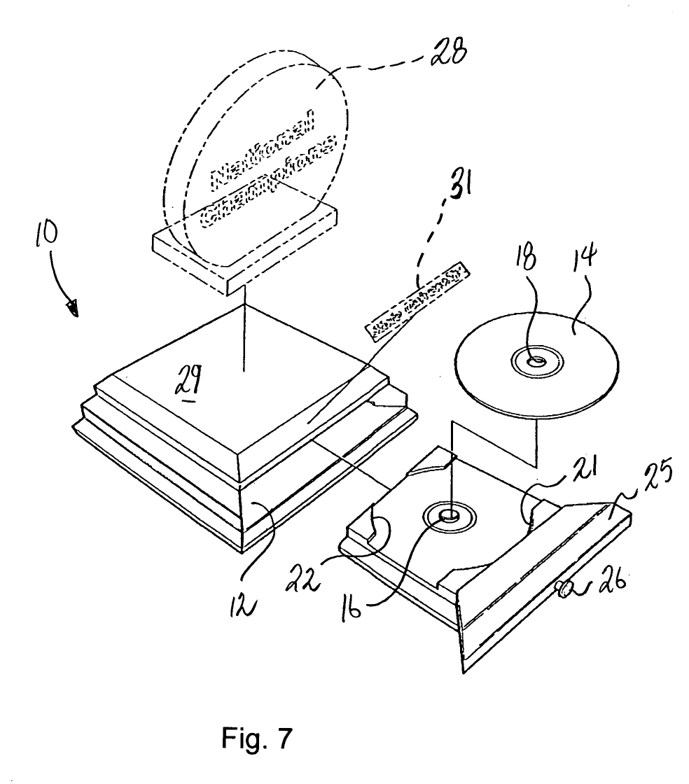

Referring to FIGS. 6 and 7, the display base 10 may further include a commemorative 28 mounted on a generally flat top display surface 29 of the housing 11. The commemorative 28 may be any object, such as a trophy, replica, award, picture frame, bust or the like which honors or preserves the memory of, or calls to mind, a person, place, thing or event. For example, the commemorative 28 may be a small trophy commemorating an athletic team's championship season, while the disk 14 contains a multimedia presentation including highlights of various games, player interviews and bios, graphics, and the like. In another example, the commemorative 28 may be a sculpture, model or other art relating to a certain interest or hobby, such as a replica miniature lighthouse, while the disk 14 contains a program on the history of lighthouses. In yet another example, the commemorative 28 is a small-scale model of a particular race car, and the disk 14 is a presentation with audio and video clips of the car and driver.

In addition to the commemorative 28, the display base may include a placard 31 attached to the housing 11 and having an inscription related to the material documented on the disk 14. Alternatively, the display base 10 may be formed in a three-dimensional decorative or ornamental structure, and itself may comprise a commemorative. The display base 10 may be constructed of any suitable material such as wood or plastic. The pre-recorded disk 14 may include any desired communications media including, but not limited to, text, graphics, voice and/or video.

A combination commemorative display base and pre-recorded disk, and a method for commemorating a person, place, thing, or event are described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

1. In combination with a pre-recorded data storage medium containing communications media documenting a person, place, thing, or event; a display base comprising:
a housing adapted for placement on a supporting surface for display; and
said housing defining a slot therein removably receiving said data storage medium for temporarily storing said data storage medium within said display base.

2. A combination according to claim 1, and comprising a tray carrying said data storage medium and slidably received through the slot formed with said housing, said tray being movable between a closed position substantially inside of said housing and an open position substantially outside of said housing.

3. A combination according to claim 2, and comprising means formed with said tray for releasably holding said data storage medium.

4. A combination according to claim 3, wherein said means for releasably holding said data storage medium comprises a raised hub insert.

5. A combination according to claim 4, and comprising a handle attached to said tray for being gripped by a user to move said tray between the closed and open positions.

6. A combination according to claim 1, wherein said housing has a generally flat top defining a display surface.

7. A combination according to claim 6, and comprising a commemorative carried on the display surface of said housing.

8. A combination according to claim 1, and comprising a placard attached to said housing.

9. A combination according to claim 1, wherein said data storage medium comprises a compact disk.

10. A combination according to claim 1, wherein said communications media is selected from a group consisting of text, graphics, voice and video.

11. A commemorative display base comprising:
a housing adapted for placement on a supporting surface for display;
said housing defining a slot therein adapted for removably receiving a pre-recorded data storage disk, the data storage disk containing communications media documenting a person, place, thing, or event;
a tray slidably received through the slot formed with said housing, and adapted for movement between a closed position substantially inside of said housing and an open position substantially outside of said housing; and
a raised hub insert located on a surface of said disk tray and adapted for releasably holding the data storage disk upon movement of the disk tray between the closed and open positions.

12. A commemorative display base according to claim 11, wherein said housing has a generally flat top defining a display surface adapted for supporting a commemorative.

13. A commemorative display base according to claim 11, and comprising a placard attached to said housing.

14. A method for commemorating a person, place, thing, or event, said method comprising the step of placing a pre-recorded data storage medium inside a display base, the data storage medium containing communications media documenting the person, place, thing, or event.

15. A method according to claim 14, and comprising the step of locating a commemorative on a display surface defined by the display base.

16. A method according to claim 14, and comprising the step of attaching a placard to the display base.
